(19) United States
(12) Patent Application Publication
(10) Pub. No.: US 2025/0120539 A1
(43) Pub. Date: Apr. 17, 2025

(54) SMOKE AND HERB FLAVORING GENERATOR FOR COOKING APPLIANCE

(71) Applicant: WHIRLPOOL CORPORATION, Benton Harbor, MI (US)

(72) Inventors: Annalisa Pacioni, Bresso (IT); Andrea Gllivanoni, Casorate Sempione (IT); Tomás Marcelo Bocco, Sesto Calende, Varese (IT); Luca Distaso, Biandronno (IT); Nicoletta Giovanna Sinelli, Biandronno (IT)

(21) Appl. No.: 18/488,550

(22) Filed: Oct. 17, 2023

(51) Int. Cl. A47J 36/20; A23B 4/052; A47J 36/32; A47J 37/06; F24C 7/08; F24C 15/32

(52) U.S. Cl. CPC A47J 36/20; A23B 4/052; A47J 36/32; A47J 37/0664; F24C 7/087; F24C 15/322

(57) ABSTRACT

A cooking appliance may include a cabinet defining a cavity having a plurality of walls for receiving food to be cooked, wherein at least one of the plurality of walls defines a receptacle; a drawer assembly for housing flavor items configured to add flavor to the food, the drawer assembly configured to be received by the receptacle; and a heating element configured to heat the flavor items to release the flavor to the food.

### TECHNICAL FIELD

Disclosed herein are smoke and herb flavoring generators for cooking appliances.

### BACKGROUND

Cooking appliances may include various cooking modes or cycles for specific food types, such as bake, roast, pizza, cookie, toast, popcorn, and bagel. Further, as meat and fish consumption is steadily increasing, smoking and additional flavoring options by way of separate appliances (e.g., smokers, etc.) are often desired.

### SUMMARY

A cooking appliance may include a cabinet defining a cavity having a plurality of walls for receiving food to be cooked, wherein at least one of the plurality of walls defines a receptacle; a drawer assembly for housing flavor items configured to add flavor to the food, the drawer assembly configured to be received by the receptacle; and a heating element configured to heat the flavor items to release the flavor to the food.

An oven for controlling a heating process may include a cabinet defining a cavity having a plurality of walls for receiving food to be cooked, wherein at least one of the plurality of walls defines a receptacle; a drawer assembly configured to be received by the receptacle for housing flavor items configured to add flavor to the food; a heating element configured to heat the flavor items to release the flavor to the food; a temperature sensor arranged in thermal contact with the drawer and configured to detect a drawer temperatures; and a processor, programmed to receive the drawer temperature from the temperature sensor and at least one user selection via a user interface, and control the heating element based on at least one of the drawer temperature and the user selection.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a front perspective view of an example oven configured to perform cooking cycles;

FIG. 2 illustrates a front perspective view of an example cavity back including a drawer assembly;

FIG. 3 illustrates a partial view of the example cavity back of FIG. 2 and a zoomed in version of the drawer assembly;

FIG. 4 illustrates a rear view of the cavity back of the example oven of FIG. 1;

FIG. 5 illustrates a rear view of the cavity back 110 for another example oven assembly; and

FIG. 6 illustrates an example controller configured to operate the components of the oven to perform cooking cycles.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Cooking meals is a part of daily life for many people. People generally prioritize taste, nutrition, cost, and ease of preparation when planning their meals. Further, as meat and fish consumption is steadily increasing, individuals are opting to buy taste-specific appliances such as smokers to achieve additional flavoring options. However, such appliances require additional space, some necessitating outdoor use. Additionally, these appliances may be larger, as well as expensive. Other smaller appliances, such as heat guns, torches, etc., may be used to flavor food via dedicated attachments. However, these appliances often require hand holding of the appliance on the food to be flavored.

Disclosed herein is a drawer assembly for a cooking appliance such as an oven. Such assembly may allow users to enjoy the functionality of a smoking appliance, within the comfort of their homes and without the need for a dedicated appliance. The assembly also allows for the possibility of combining smoking processes with other more traditional cooking processes such as roasting, forced convection, etc. Thus, it may now be possible for users to obtain combination flavors that are traditionally not possible with separate cooking and smoking appliances.

The drawer assembly may be housed in a dedicated opening in the back wall of the oven cavity. In one example, the drawer assembly may be near or close to a heating element. The drawer assembly may have small holes on one or more sides in order to facilitate oxygenation and circulation of the smoke. This may be further facilitated via airflow generated by an oven fan, typically mounted concentrically to the ring element. In another embodiment, the drawer assembly may have different amounts and sizes of holes in order to optimize and customize smoke circulation inside the oven cavity.

The drawer assembly may be easily removable to clean and refill. The drawer assembly may be configured to hold wood chips, for example, and may include a handle on a front face to facilitate inserting and removing of the drawer assembly from the receptacle in the oven wall.

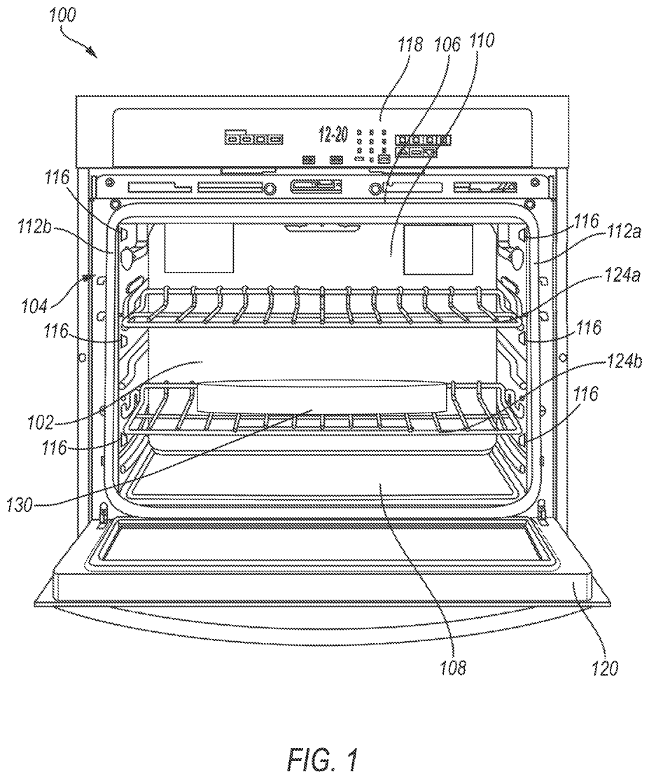

FIG. 1 illustrates an example front perspective view of an oven 100 configured to perform real-time automated cooking cycles. The oven 100 may be one of various cooking appliances, such as a conventional oven, a convection oven, a conduction oven, a microwave oven, a toaster oven. In some examples, the oven 100 may be a function-specific oven, such as a roaster oven, a pizza oven, etc. The oven 100 may be a standalone oven in some cases, while in other cases the oven may be built-in or a component of a combination oven and stove top.

The oven 100 may form a cabinet 104 and define a cavity 102 having a cavity top 106, cavity bottom 108, cavity back 110, and side walls 112. A door assembly 120 may be hinged at a front of the cavity bottom 108 to permit access to the cavity 102. The door assembly 120 may include a window and a handle, and may hermetically seal the cavity when the door is in a closed position. It should be noted that this is an example, and ovens 100 with different types of doors may be used. For instance, a door may be hinged at a side instead of the bottom. A door sensor may be arranged on the door or the cavity 102 to detect an open and closed position of the door of the door assembly 120.

The cavity 102 may be configured to receive food items for cooking, baking, and/or broiling during a cooking cycle. The cavity 102 may also include temperature sensors 116 for determining the air temperature within the cavity 102 during cooking. The oven 100 may further include a user interface 118 configured to receive user input with respect to cycles or other oven operation. The user interface 118 may also provide information to the user such as cook time, temperature, smoke and herb flavoring settings, etc. Specifically, users may be able to select certain smoking options via the user interface 118, such as type of items to smoke (wood, herbs, etc.), time, food items, etc.

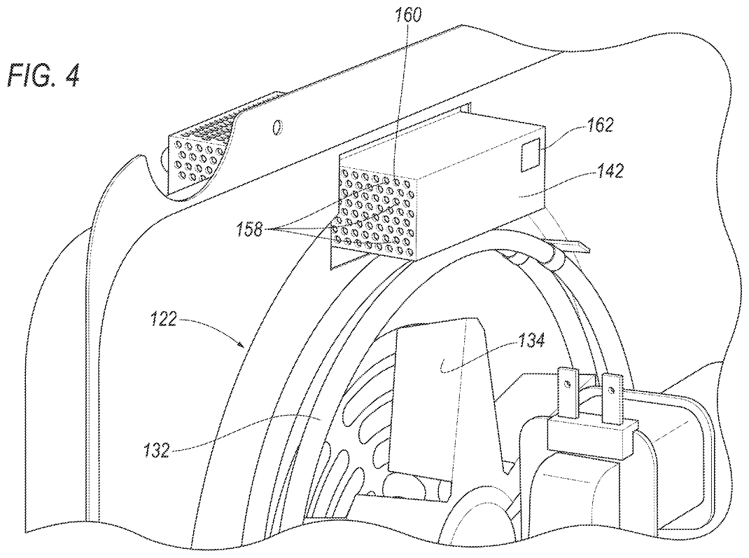

As best shown in FIG. 4, the oven 100 may include a heating system 122 for heating the cavity 102 during cooking. The heating system 122 may include one or more heating elements, such as a gas heating element or an electric heating element. In the example shown in FIG. 4, the heating system 122 may include a heat ring 132 arranged behind the cavity back 110. A fan assembly 134 may be arranged in the center of the heat ring 132. The fan assembly 134 may be configured to circulate air through the cavity 102 during heating of the cavity 102.

Referring back to FIG. 1, the oven 100 may include one or more racks 124 within the cavity 102 for supporting the food items during cooking. As shown by way of example in FIG. 1, the oven 100 may include a top rack 124a and a bottom rack 124b (collectively referred to herein as racks 124). It should be noted that while two racks 124 are shown, ovens 100 with more or fewer racks 124 are possible. Regardless of quantity, the racks 124 may rest on side rails arranged along the side walls 112. The side rails may extend parallel or generally parallel with the cavity top 106 and cavity bottom 108 along the side walls 112 at spaced intervals. The side rails may extend up the height of the side walls 112 to allow for varying positions of the racks 124 within the cavity 102. For each side rail arranged on the first side wall 112a, a corresponding side rail is arranged on the opposite second side wall 112b (generally at the same relative height) so that the rack 124 may be evenly maintained on each side thereof. As explained, food may be placed in a container 130 on one of the racks 124 for cooking.

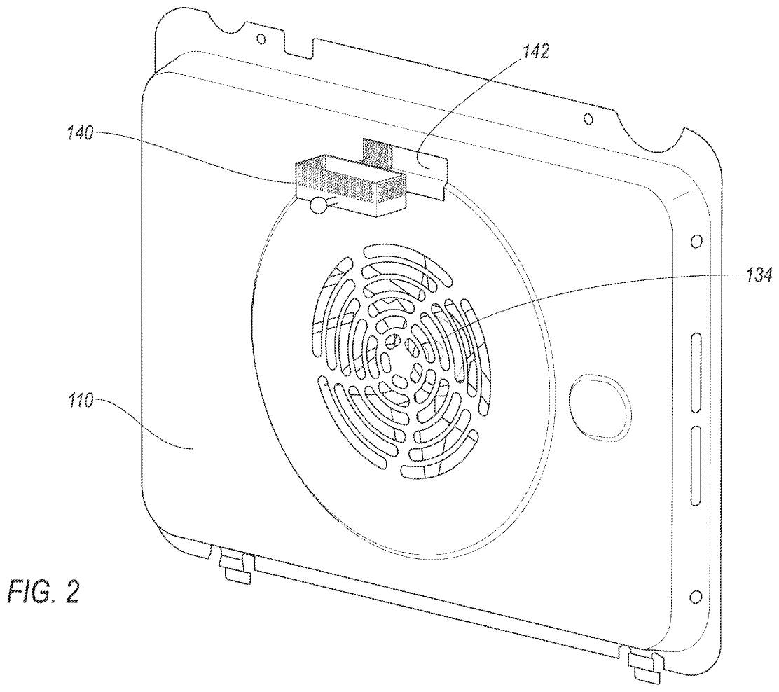

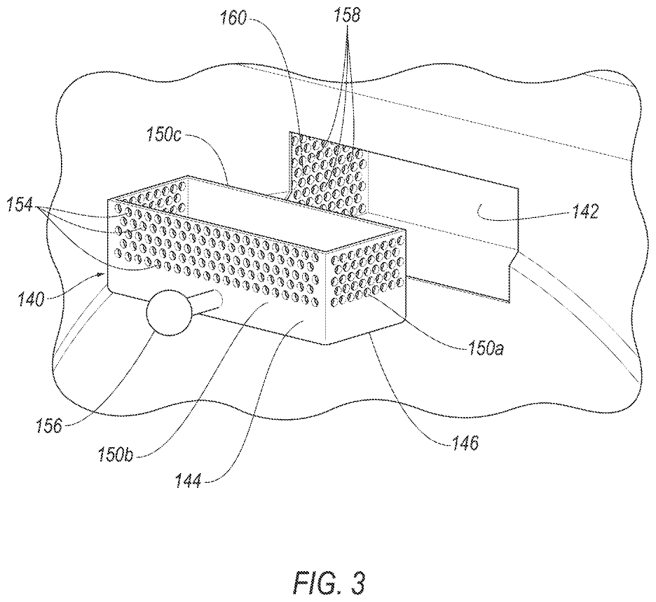

FIG. 2 illustrates a front perspective view of an example cavity back 110 including a drawer assembly 140. FIG. 3 illustrates a partial view of the example cavity back 110 and a zoomed in version of the drawer assembly 140. Referring to FIGS. 2 and 3, the cavity back 110 may define at least one receptacle 142 configured to receive the drawer assembly 140.

The drawer assembly 140 may be a cuboid or cube, but may also take on other shapes. In the example shown in FIGS. 2 and 3, the drawer assembly 140 may include a drawer portion 144 having an open top and being configured to receive items, such as wood chips, herbs, etc. These items, as explained, may be used to add flavoring to the food. The drawer portion 144 may include four sides 150, including two sides 150a, a drawer front 150b, and a drawer back 150c, and a drawer bottom 146. At least a portion of the four sides 150 may define a plurality of drawer openings 154. In one example, the sides 150a and front 150b may define the openings 154, while the back 150c is solid. The drawer openings 154 may allow for air to circulate through the drawer assembly 140, allowing particles from the items within the drawer portion 144 to circulate throughout the cavity 102 of the oven 100. While the openings 154 are shown as a plurality of round holes, other shapes, sizes and variations may be appreciated. Slots may be used, as well as a combination of slots, holes, etc. The openings 154 may be dimensioned such as to create a large enough air flow while maintaining the items within the drawer and the rigidity of the drawer sides 150.

The drawer assembly 140 may include a handle 156. The handle 156 may be arranged on the drawer front 150b to allow a user to easily insert and remove the drawer assembly 140 from the receptacle 142. The handle 156 may be made of a similar material as that of the drawer portion 144, such as metal. However, in some examples, the handle 156 may be made of a heat resistant material such as silicon. In some examples, the handle 156 may connect to a grasping tool. The grasping tool may allow users to easily reach the drawer assembly 140 without having to reach into the oven 100.

Similarly, the receptacle 142 may also define a cuboid of similar dimensions to the drawer assembly 140 in order to receive the drawer assembly 140. The receptacle 142 is illustrated in FIG. 2 as being arranged near the top of the cavity back 110 of the oven cavity 102, but may be arranged at other locations on the cavity back 110 as well as other walls. At least one of the sides defining the receptacle 142 may define a plurality of receptacle openings 158. These openings may be similar to and aligned with the drawer openings 154 in that the openings allow air to flow therethrough.

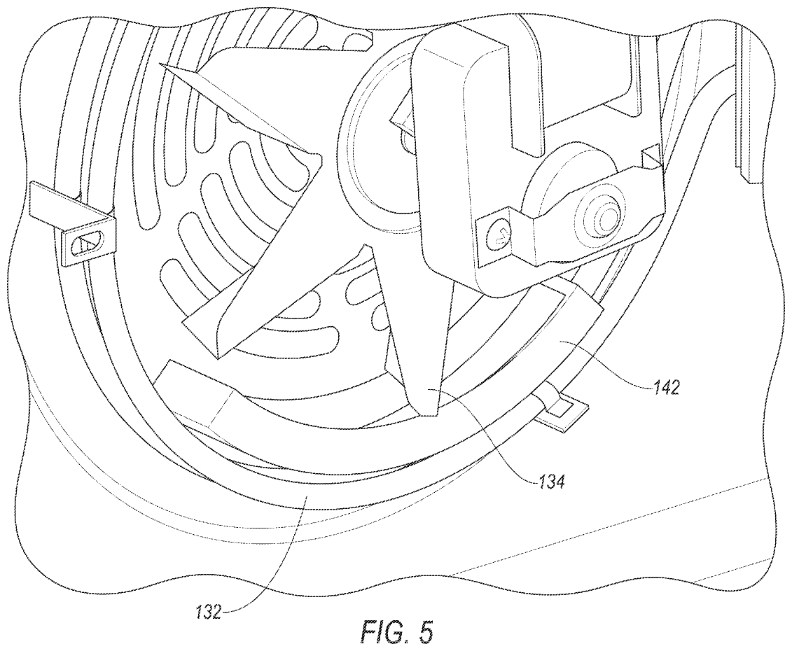

Such air flow may be generated, in part, by the fan assembly 134 as described in more detail with respect to FIGS. 4 and 5. The fan assembly 134, which is labeled in FIG. 2, but best shown in FIGS. 4 and 5, may be arranged behind the cavity back 110 and may circulate air through the oven cavity 102. The receptacle openings are illustrated as being defined on a receptacle side 160, though additional openings may be defined on a back and bottom of the receptacle. The receptacle openings 158 may be configured to align with the drawer openings 154 when the drawer assembly 140 is inserted in the receptacle 142. The receptacle openings 158 are further illustrated in FIG. 4.

Similar to the drawer openings 154, while the receptacle openings 158 are shown as a plurality of round holes, other shapes, sizes and variations may be appreciated. Slots may be used, as well as a combination of slots, holes, etc. The receptacle openings 158 may be dimensioned such as to create a large enough air flow while maintaining the rigidity of the receptacle shape.

FIG. 4 illustrates a rear view of the cavity back 110, where the receptacle 142 is arranged adjacent, and specifically above the heat ring 132. By arranging the receptacle 142, and thus the drawer assembly 140, adjacent to the heat ring 132, the heat ring 132 may provide heat to the drawer assembly 140 and the contents therein. Such heat may cause the contents of the drawer portion 144 to start to smoke and release certain aromas, particles, etc., from the contents (e.g., wood chips, herbs, etc.,). The fan assembly 143 may circulate air through the cavity 102 as well as through the receptacle 142 and drawer assembly 140. The air circulation aids in the release of flavoring from the contents of the drawer portion 144 and increases distribution throughout the cavity, thus allowing flavoring to be added to food within the oven cavity.

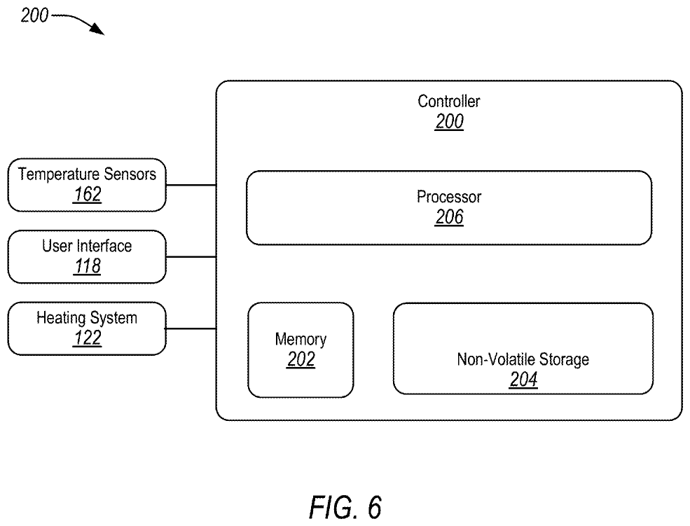

A temperature sensor 162 may be arranged at, near, or within the receptacle 142, as best illustrated in FIG. 4. The temperature sensor 162 may be configured to detect the temperature of the drawer assembly 140. The temperature sensor 162 may be in communication with a controller (illustrated and explained further with respect to FIG. 6) for controlling the heating of the drawer assembly contents.

FIG. 5 illustrates a rear view of the cavity back 110 for another example drawer assembly 140. In this example, the drawer assembly 140 is arranged adjacent to the heat ring 132, but has a concave-like shape. In this example, the drawer assembly 140 may mimic the curvature of the heat ring 132. This may allow more surface area of the drawer assembly 140 to be adjacent to the heat ring 132, thus allowing more heat to transfer to the drawer assembly 140, and therefore allowing greater distribution of flavoring through the cavity 102. Though not shown, features such as the receptacle 142, drawer openings 154 and receptacle openings 158 may also be appreciated with this example.

Further, while a single fan assembly 134, heat ring 132, drawer assembly 140, etc., are illustrated in the figures, it may be appreciated that more than one of each of these elements may be incorporated into the oven 100. In one example, two fans at each top corner of the oven 100 may be included. The drawer assembly 140 may be arranged between the fans, or multiple drawer assemblies may be included. Further, such arrangements may be on the oven sides 104. The heating element, while shown as a ring 132, may be in other forms or shapes.

FIG. 6 illustrates an example controller configured to operate the components of the smart oven. The controller 200 may include a memory 202, a non-volatile storage 204, and a processor 206. The non-volatile storage 204 may store operations for smoke and herb flavoring settings.

The memory 202 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. The non-volatile storage 204 may include one or more persistent data storage devices such as a hard drive, optical drive, tape drive, non-volatile solid-state device, cloud storage or any other device capable of persistently storing information.

The processor 206 may include one or more microprocessors, micro-controllers, digital signal processors, microcomputers, central processing units (CPU), graphical processing units (GPU), tensor processing units (TPU), field programmable gate arrays, programmable logic devices, state machines, logic circuits, analog circuits, digital circuits, or any other devices that manipulate signals (analog or digital) based on computer-executable instructions residing in memory 202.

The processor 206 may be configured to read into memory 202 and execute computer-executable instructions residing in the non-volatile storage 204. Upon execution by the processor 206, the computer-executable instructions may cause the oven 100 to implement one or more of the algorithms and/or methodologies disclosed herein.

The controller 200 may be electrically connected to signaling interfaces of other components of the smart oven 100, thereby allowing the processor 206 of the controller 200 to manipulate the functions of the smart oven 100. For example, the controller 200 may be configured to receive user input from the user interface 118, such as requests to initiate a cooking cycle. The controller 200 may also be configured to control operation of the heating system 122, including to apply power to heating elements of the heating system 122 to warm the cavity 102, as well as to discontinue applying power to the heating element of the heating system 122, in addition to controlling the fan assembly 134. The controller 200 may also control a door lock to selectively control the latch mechanism of the door assembly 120 to prevent the door assembly 120 from being opened during the cycle.

The controller 200 may also be configured to receive input from other sensors to support the operation of the oven, including smoking and/or flavoring preferences. This may include input from sensors such as the temperature sensor 162. This may also include input from one or more additional sensors throughout the oven 100.

The temperature sensor 162 may detect the temperature of the drawer assembly 140. The controller 200 may receive a drawer temperature and use the drawer temperature to control the heating system 122 so that the content of the drawer assembly achieves a desired temperature. For example, the controller 200 may heat the heat ring 132 with a specific heat profile over time. The heat ring 132 may heat the wood chips to the point where they begin to smoke, thus releasing the desirable flavor compounds. It is also desirable to not completely burn the wood chips, which may result in undesirable, more acrid, compounds to be released. In one example, the desired temperature is below 350 degrees Celsius. The user may select a dedicated program via the user interface 118 to activate a smoking feature or function, in combination with other cooking functions or settings.

Further, while wood chips are used as an example herein, other contents may be used to flavor food via the drawer assembly 140. For example, chopped or minced herbs or a combination of herbs and wood chips may be used (e.g., rosemary, juniper, sage, etc.). The user has the ability to customize a preferred flavor based on combinations, quantities, etc. In the example of herbs, a specific setting via the user interface 118 may be selected, as herbs require a lower temperature than wood chips for their aromatic compounds to be released without burning. Thus, a dedicated program may be used to activate the herb flavoring function. Further, specific herbs may each have a specific temperature profile.

Accordingly, a smoke and herb flavoring generator for a cooking appliance is described herein. The small drawer capable of housing items that add flavoring to food may be arranged in a housing in the back wall of the oven. The small holes in the housing and the drawer may allow oxygenation and circulation of the smoke, imparted by airflow generated by the main cavity fan. The fan may be mounted concentrically with a ring element to allow heat to best reach the items in the drawer. Other variations of the drawer shape, hole arrangement and configuration, as well as placement in the cavity may be appreciated.

Users may thus easily remove the drawer and reinsert the drawer at will. Further, such integration with a household appliance reduces the need for an additional, large appliance for a smoking function.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

The flowcharts and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A cooking appliance, comprising:
a cabinet defining a cavity having a plurality of walls for receiving food to be cooked, wherein at least one of the plurality of walls defines a receptacle;
a drawer assembly for housing flavor items configured to add flavor to the food, the drawer assembly configured to be received by the receptacle; and
a heating element configured to heat the flavor items to release the flavor to the food.

2. The appliance of claim 1, wherein the drawer assembly includes a drawer portion defined by a plurality of sides, at least one of the plurality of sides defining a plurality of drawer openings configured to allow air to circulate therethrough to disperse the flavor into the cavity.

3. The appliance of claim 2, wherein the receptacle defines a plurality of receptacle openings configured to allow air to circulate through the drawer assembly when the drawer assembly is inserted into the receptacle.

4. The appliance of claim 3, wherein at least a portion of the receptacle openings align with the drawer openings when the drawer assembly is inserted in the receptacle.

5. The appliance of claim 4, further comprising a fan assembly arranged within the at least one of the walls defining the receptacle to generate air flow through the receptacle openings and the drawer openings when the drawer assembly is inserted in the receptacle.

6. The appliance of claim 1, further comprising a fan assembly arranged within the at least one of the walls defining the receptacle to generate air flow through the receptacle and the drawer assembly when the drawer assembly is inserted in the receptacle.

7. The appliance of claim 1, wherein the drawer assembly includes a handle to facilitate removal from and insertion into the receptacle.

8. The appliance of claim 1, wherein the drawer assembly and the receptacle are each cuboids.

9. The appliance of claim 1, wherein the heating element is a heat ring.

10. The appliance of claim 9, wherein the drawer assembly forms a curved shape and is arranged around a curve of the heat ring when inserted in the receptacle.

11. An oven for controlling a heating process, comprising:
a cabinet defining a cavity having a plurality of walls for receiving food to be cooked, wherein at least one of the plurality of walls defines a receptacle;
a drawer assembly configured to be received by the receptacle for housing flavor items configured to add flavor to the food;
a heating element configured to heat the flavor items to release the flavor to the food;
a temperature sensor arranged in thermal contact with the drawer and configured to detect a drawer temperatures; and
a processor, programmed to receive the drawer temperature from the temperature sensor and at least one user selection via a user interface, and control the heating element based on at least one of the drawer temperature and the user selection.

12. The oven of claim 11, wherein the user selection includes a smoke feature and flavor source, wherein the processor is further programmed to control the temperature of the heating element based at least in part on the flavor source.

13. The oven of claim 11, wherein the drawer assembly includes a drawer portion defined by a plurality of sides, at least one of the plurality of sides defining a plurality of drawer openings configured to allow air to circulate therethrough to disperse the flavor into the cavity.

14. The oven of claim 13, wherein the receptacle defines a plurality of receptacle openings configured to allow air to circulate to the drawer assembly when the drawer assembly is inserted in the receptacle.

15. The oven of claim 14, wherein at least a portion of the receptacle openings align with the drawer openings when the drawer apparatus is inserted in the receptacle.

16. The oven of claim 15, further comprising a fan assembly arranged within the at least one of the walls defining the receptacle to generate air flow through the receptacle openings and the drawer openings when the drawer is inserted in the receptacle.

17. The oven of claim 11, further comprising a fan assembly arranged within the at least one of the walls defining the receptacle to generate air flow through the receptacle and the drawer when the drawer is inserted in the receptacle.

18. The oven of claim 11, wherein the drawer assembly includes a handle to facilitate removal from and insertion into the receptacle.

19. The oven of claim 11, wherein the drawer assembly and the receptacle are each cuboids.

20. The oven of claim 11, wherein the heating element is a heat ring and wherein the drawer assembly forms a curved shape and is arranged around a curve of the heat ring when inserted in the receptacle.
